(19) United States
(12) Patent Application Publication
(10) Pub. No.: US 2020/0094435 A1
(43) Pub. Date: Mar. 26, 2020

(54) Rapid cleaning device for summer sleeping mat production

(71) Applicant: Yongjun Shu, Foshan City (CN)

(72) Inventor: Yongjun Shu, Foshan City (CN)

(21) Appl. No.: 16/697,199

(22) Filed: Nov. 27, 2019

(30) Foreign Application Priority Data
Aug. 16, 2019 (CN) 2019107582006

(51) Int. Cl. B27M 3/04; B08B 3/04; B08B 1/02; F26B 3/04; F26B 13/10

(52) U.S. Cl. CPC B27M 3/04; B08B 3/041; B27K 9/002; F26B 3/04; F26B 13/108; B08B 1/02

(57) ABSTRACT

The invention discloses a rapid cleaning device for producing mats, which includes a washing machine. The washing machine is provided with a cleaning chamber with an upward opening. The left and right sides of the cleaning chamber are provided with rotation wheels. A conveyer belt is wound around the conveyer wheels. The conveyer belt is recessed downward in the middle and immersed in the cleaning liquid. In the present invention, the mat is immersed in the conveying process. In the cleaning liquid, the bamboo surface is polished and washed to remove burrs and stains on the bamboo surface of the mat, and then the mat is dried at high temperature quickly to ensure that it is not affected by moisture during subsequent processing. At the same time, the device mat is adjusted to ensure that the mat does not shift during transportation.

### CROSS-REFERENCES TO RELATED APPLICATIONS

The present application claims priority from Chinese application No. 2019107582006 filed on Aug. 16, 2019 which is hereby incorporated by reference in its entirety.

### TECHNICAL FIELD

The invention relates to the technical field of cooling mat production, in particular to a rapid cleaning device for summer sleeping mat production.

### BACKGROUND OF THE INVENTION

In the production process of mats, we first need to weave the mats into long strips, and then cut the long mats into mats of the required length. In this process, the mats are hardly treated, and the burrs on the mats are likely to cause injuries to workers. At the same time, the dust in the mat will pollute the air, and then endanger the workers' body. Therefore, the prepared mat must be polished and washed. The present invention illustrates a device capable of solving the above problems.

### BRIEF SUMMARY OF THE INVENTION

Technical problem: in the production of mats in the traditional process, after the mats are prepared, there is almost no cleaning treatment, which causes burrs and dust on the mats to endanger workers' bodies.

In order to solve the above problem, this example designs a rapid mat cleaning device. The rapid mat cleaning device of this example includes a washing machine. The washing machine is provided with a cleaning chamber with an upward opening in the washing machine. Conveying wheels are rotatably provided between the left and right sides of the wall, and a conveying belt is wound around the conveying wheels. The conveying belt is recessed downward and immersed in the cleaning liquid. Clamping rollers on the front and rear walls of the cleaning chamber, cleaning rollers are provided between the front and rear walls of the cleaning chamber and can rotate on the upper side of the recess of the conveyor belt, and the clamping rollers on the left side clamp the mat And input to the right, the mat is transported down into the cleaning liquid through the conveyor belt, the bamboo surface of the mat is polished and washed by the cleaning roller, and then the mat is transported to the upper right by the conveyor belt, The clamping roller on the side clamps the mat and conveys it to the right. The upper side of the left wall of the cleaning chamber is connected with an inlet opening to the right. The inlet is symmetrical and slidably provided with a limit block. Both sides of Opposite sides of the block are provided with opposite guide slideways. The front and back ends of the mat are restricted by the limit blocks, and the front and back ends of the mat are passed through the guide slides on the front and back sides, respectively. Position the mats to prevent them from shifting.

Preferably, an adjustment device is provided on the upper side of the inlet, and the adjustment device can adjust the distance between the limiting blocks, which is further applicable to cooling mats of different widths. The upper side of the right wall of the cleaning chamber communicates A drying channel is provided. A drying device is provided in the right wall of the drying channel. The drying device is provided with a blower fan. An upper side of the blower fan is provided with a suction fan. The washed mat enters the drying channel. The blower fan blows hot air onto a mat for high-temperature drying, and the humid hot air is sucked out by the suction fan to ensure the drying of the air in the drying channel. A transmission device is provided in the rear wall of the cleaning chamber. The transmission device can synchronously drive the conveying wheel, the clamping roller and the cleaning roller to rotate.

Wherein, the adjusting device includes an adjusting cavity which is symmetrically arranged forward and backward and communicates with an upper wall of the adjusting cavity. An adjusting block is slidably provided in the adjusting cavity. The clamping roller is fixedly connected to the lower end of the adjusting block. A screw screwed to the adjusting block is rotatably provided between the front and rear walls of the adjusting cavity, a bevel gear cavity is provided in an inner wall between the adjusting cavity, and one end of the screw near the center of symmetry extends to the A driven bevel gear is fixed in the bevel gear cavity, and a driving bevel gear engaging the driven bevel gears on the front and rear sides is rotatably provided on the upper wall of the bevel gear cavity. A power shaft, the upper end of the power shaft extending to the outside is fixed with a turntable

Wherein, the drying device includes a blower cavity connected to the right wall of the drying channel, the blower fan is rotatably provided on the right wall of the blower cavity, and a heating net is fixed on the left side of the blower cavity. The upper side of the blowing cavity is provided with an air suction cavity connected to the drying channel. The air suction fan is rotatably provided on the right wall of the air suction cavity. Ventilation net.

Preferably, a sprocket cavity is provided on the right side of the blower cavity and the suction cavity, and an active sprocket fixedly connected to the blower fan is rotatably provided on the lower side of the sprocket cavity. A driven sprocket fixedly connected to the suction fan is rotatably provided on the upper side of the wheel cavity, and a chain is wound between the driving sprocket and the driven sprocket.

Preferably, a first motor is fixed at the lower inner end of the right wall of the sprocket cavity, and the active sprocket is dynamically connected to the left end of the first motor.

Preferably, an air inlet opening to the right is connected to the lower side of the right wall of the blowing cavity, and an air outlet opening to the right is connected to the upper side of the air suction cavity.

Wherein, the transmission device includes a transmission cavity provided in the rear wall of the cleaning cavity, and a driving belt pulley fixedly connected to the rear end of the cleaning roller is rotatably provided on the lower middle side of the transmission cavity, and the transmission cavity The left and right sides are symmetrical and rotatable with a driven pulley fixedly connected to the rear end of the conveying wheel, and a driving belt is wound between the driving pulley and the driven pulley, and the driven pulley A driving spur gear is fixedly connected to the rear axle center, and a driven spur gear fixedly connected to the rear end of the clamping roller is provided on the upper side of the driving spur gear.

Preferably, a second motor is fixed in the rear wall of the transmission cavity and directly opposite the rear side of the driving pulley, and the driving pulley is dynamically connected to the front end of the second motor.

Preferably, the lower side of the front and rear walls of the cleaning chamber is symmetrical and fixed with an arc-shaped upper rail, and the front and back walls of the cleaning chamber are symmetrical and fixed with a lower rail on the lower side of the upper rail, and the lower rail is fixed. The radius of the arc is larger than the radius of the upper rail. The front and back ends of the upper part of the conveyor belt extend into the upper rails on the front and back sides. The front and back ends of the lower part of the conveyor belt extend to the front and back sides. In the lower guide rail on the side, the conveying track of the conveyor belt is fixed by the upper guide rail and the lower guide rail.

The beneficial effect of the present invention is that: by dipping the mat into the cleaning solution during the transportation process, the invention polishes and cleans the bamboo surface, removes burrs and stains on the bamboo surface of the mat, and then quickly heats the mat to ensure that It is not affected by moisture during subsequent processing. At the same time, the device can be adjusted according to different width mats to ensure that the mats will not shift during the transportation.

### BRIEF DESCRIPTION OF THE DRAWINGS

For ease of description, the present invention is described in detail by the following specific embodiments and the accompanying drawings.

FIG. 1 is a schematic diagram of the overall structure of a rapid cleaning device for producing mats according to the present invention; FIG.

[symbol]

FIG. 2 is a schematic structural diagram of the direction “A-A” of FIG. 1; FIG.

[symbol]

FIG. 3 is a schematic structural diagram in a direction “B-B” of FIG. 2;

FIG. 4 is an enlarged schematic view of the structure of “C” in FIG. 1;

FIG. 5 is a schematic structural diagram of the “D-D” direction of FIG. 1.

### DETAILED DESCRIPTION OF THE INVENTION

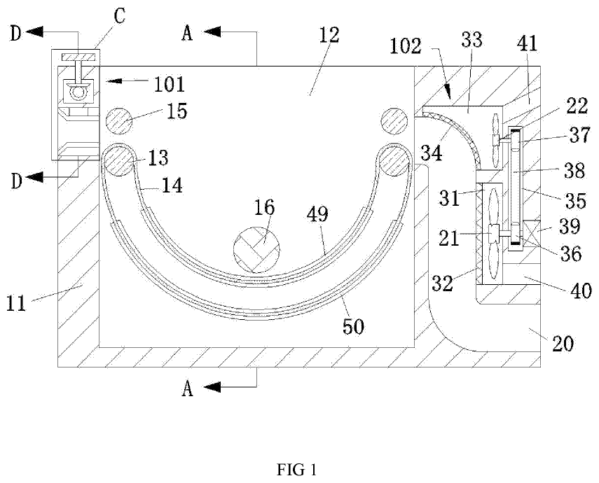

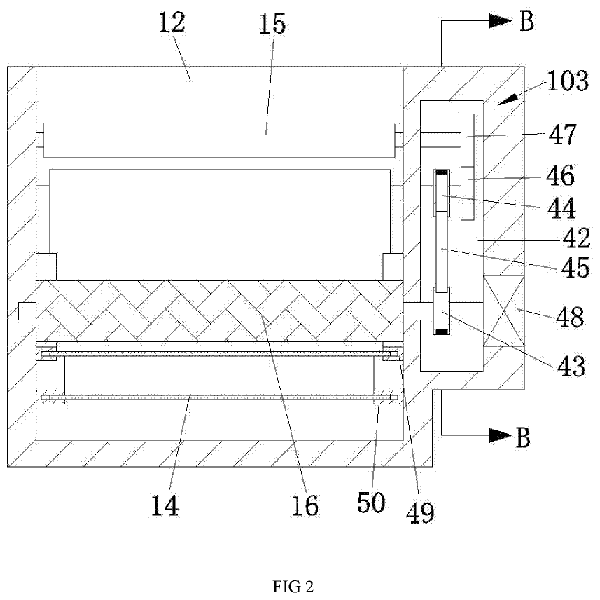

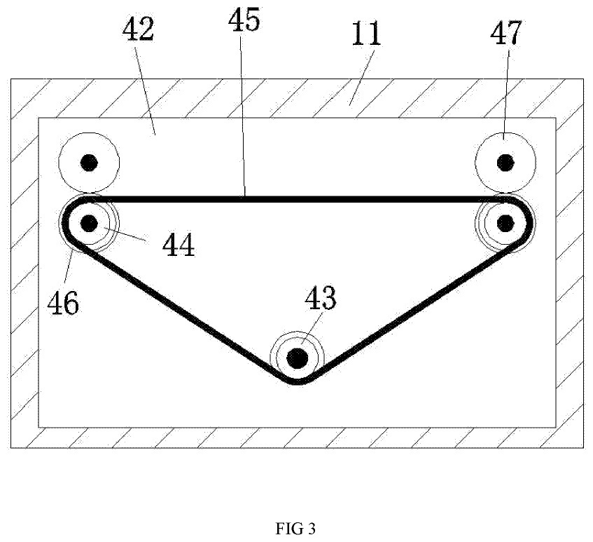

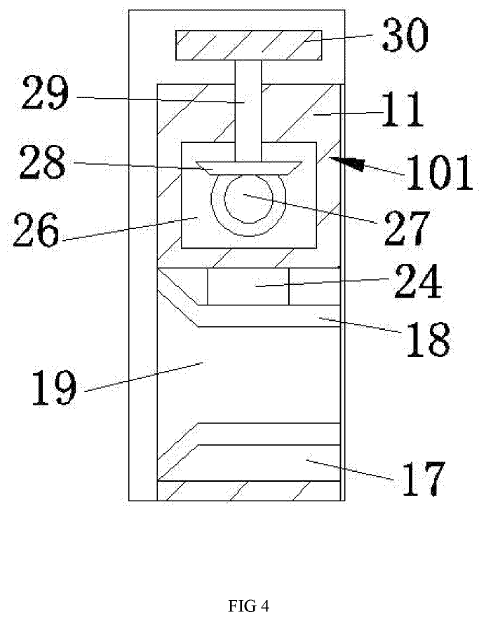

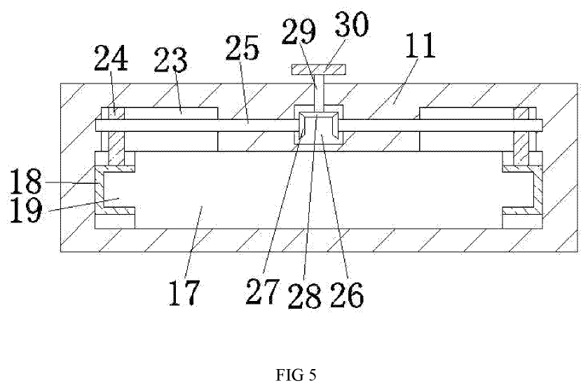

The present invention is described in detail below with reference to FIGS. 1-5. For convenience of description, the orientation described below is defined as follows: the up-down, left-right, front-back direction described below is consistent with the up-down, left-right, front-back direction of the projection relationship of FIG. 1 itself.

The invention relates to a rapid cleaning device for the production of cooling mats, which is mainly used for the cleaning and drying of cooling mats during the production of cooling mats. The invention will be further described below with reference to the accompanying drawings of the present invention:

The invention relates to a rapid cleaning device for producing mats, which comprises a washing machine 11, which is provided with a cleaning chamber 12 with an opening upward, and the left and right sides of the cleaning chamber 12 are rotatably provided with A conveying wheel 13 is surrounded by a conveying belt 14. The conveying belt 14 is recessed downward in the middle and immersed in the cleaning liquid. The conveying wheel 13 is provided above the conveying wheel 13 and is connected to the front and rear of the cleaning chamber 12. A wall clamping roller 15 is provided between the front and rear walls of the cleaning chamber 12 and a cleaning roller 16 is rotatable on the upper side of the recess of the conveyor belt 14. The left side clamping roller 15 clamps the mat And input to the right, the mat is conveyed downward into the cleaning liquid through the conveyor belt 14, the bamboo surface of the mat is polished and washed by the cleaning roller 16, and then the mat is conveyed to the upper right by the conveyor belt 14 The mat is clamped and conveyed to the right by the clamping roller 15 on the right side. The upper side of the left wall of the cleaning chamber 12 is provided with an inlet 17 opening to the right. The inlet 17 is symmetrical and slidable forward and backward. The limiting block 18 is provided, and the limiting block 18 on the front and back sides runs sideways. A guide slideway 19 is provided with opposite openings. The front and rear ends of the mat are restricted by the limiting block 18, and the front and back ends of the mat are passed through the guide slideways 19 on the front and back sides, respectively. Positioning of the conveyor to avoid shifting of the mat.

Beneficially, an adjusting device 101 is provided on the upper side of the inlet 17, and the adjusting device 101 can adjust the distance between the limiting blocks 18, which is further applicable to cooling mats of different widths. The right wall of the cleaning chamber 12 A drying passage 20 is communicated with the upper side of the inside, and a drying device 102 is provided in the right wall of the drying channel 20. A drying fan 21 is provided in the drying device 102, and a suction fan 22 is provided on the upper side of the drying fan 21. The cleaned mat enters the drying channel 20, the blower fan 21 blows hot air onto the mat for high-temperature drying, and the humidified hot air is sucked out by the suction fan 22 to ensure the drying of the air in the drying channel A transmission device 103 is provided in the rear wall of the cleaning chamber 12, and the transmission device 103 can synchronously drive the conveying wheel 13, the clamping roller 15, and the cleaning roller 16 to rotate.

According to the embodiment, the adjustment device 101 is described in detail below. The adjustment device 101 includes an adjustment cavity 23 that is symmetrically arranged forward and backward and communicates with the upper wall of the adjustment cavity 23. The adjustment cavity 23 is provided with an adjustment that can be slid back and forth. Block 24, the clamping roller 15 is fixedly connected to the lower end of the adjusting block 24, and a screw 25 screwed to the adjusting block 24 is rotatably provided between the front and rear walls of the adjusting cavity 23, and the adjusting cavity 23 A bevel gear cavity 26 is provided in the inner wall therebetween, and one end of the screw 25 near the center of symmetry extends into the bevel gear cavity 26 to be fixed with a driven bevel gear 27. The upper wall of the bevel gear cavity 26 is rotatable. A driving bevel gear 28 is engaged with the driven bevel gears 27 on the front and rear sides. The driving bevel gear 28 is fixedly provided with a power shaft 29 at an axial center thereof, and an upper end of the power shaft 29 is fixedly provided with a turntable 30.

According to an embodiment, the drying device 102 is described in detail below. The drying device 102 includes a blowing cavity 31 connected to the right wall of the drying channel 20, and the blowing fan 21 is rotatably provided at the right of the blowing cavity 31. Wall, a heating net 32 is fixed on the left side of the blowing cavity 31, and an air suction cavity 33 communicating with the drying channel 20 is provided on the upper side of the blowing cavity 31, and the suction fan 22 is rotatably provided on the An air ventilation net 34 is provided at the right wall of the air suction cavity 33 and the air suction cavity 33 communicates with the drying channel 20.

Beneficially, a sprocket cavity 35 is provided on the right side of the blowing cavity 31 and the suction cavity 33, and an active sprocket fixedly connected to the blowing fan 21 is rotatably provided on the lower side of the sprocket cavity 35. 36. A driven sprocket 37 fixedly connected to the suction fan 22 is rotatably provided on the upper side of the sprocket cavity 35, and the driving sprocket 36 and the driven sprocket 37 are wound around the driven sprocket 37. There are chains 38.

Beneficially, a first motor 39 is fixed on the lower inner right end of the sprocket cavity 35, and the active sprocket 36 is dynamically connected to the left end of the first motor 39.

Beneficially, an air inlet 40 opening to the right is connected to the lower side of the right wall of the blowing cavity 31, and an air outlet 41 opening to the right is connected to the upper side of the air suction cavity 33.

According to the embodiment, the transmission device 103 is described in detail below. The transmission device 103 includes a transmission cavity 42 provided in the rear wall of the cleaning chamber 12, and a fixed connection is rotatably provided on the lower middle side of the transmission cavity 42. On the driving pulley 43 at the rear end of the cleaning roller 16, the left and right sides of the transmission cavity 42 are symmetrically and rotatably provided with driven pulleys 44 fixedly connected to the rear end of the conveying wheel 13, and the driving pulley A driving belt 45 is wound around 43 and the driven pulley 44. A driving spur gear 46 is fixedly connected to the rear end of the driven pulley 44. A fixed fixed meshing upper side of the driving spur gear 46 is provided. A driven spur gear 47 connected to the rear end of the clamping roller 15.

Beneficially, a second motor 48 is fixed in the rear wall of the transmission cavity 42 and directly opposite the rear side of the driving pulley 43, and the driving pulley 43 is dynamically connected to the front end of the second motor 48.

Advantageously, the lower side of the front and rear walls of the cleaning chamber 12 are symmetrical and fixed with an arc-shaped upper guide 49, and the front and rear walls of the cleaning chamber 12 are symmetrical with the lower side of the upper guide 49 and fixed with a lower guide 50, The arc radius of the lower guide rail 50 is larger than the radius of the upper guide rail 49. The front and rear ends of the upper portion of the conveyor belt 14 extend into the upper guide rail 49 at the front and rear sides. The front and rear ends of the portion extend into the lower rail 50 on the front and back sides, and the transport track of the conveyor belt 14 is fixed by the upper rail 49 and the lower rail 50.

The following describes in detail the use steps of a rapid cleaning device for producing mats in this article with reference to FIGS. 1 to 5:

During cleaning, manually turn the turntable 30, drive the driving bevel gear 28 through the power shaft 29, drive the driven bevel gear 27 through the gear meshing and drive the screw 25, and adjust the blocks 24 to move closer to or farther from each other through the screw connection, and then adjust the limit The spacing between the blocks 18 matches the width of the mat to be cleaned. Input the mat with bamboo facing up from the opening on the left side of the inlet 17, pass the front and rear ends of the mat through the guide rail 19, and lift the mat. The starting end extends between the clamping roller 15 and the conveying wheel 13 on the left side and clamps. The second motor 48 is started and drives the driving pulley 43 to rotate. The driven belt 44 is driven to rotate by the transmission belt 45 and the driving spur gear 46 is rotated. The driven spur gear 47 rotates in the reverse direction through the gear meshing, the driving pulley 43 drives the cleaning roller 16 to rotate clockwise, the driven pulley 44 drives the conveying wheel 13 to rotate clockwise, and the driven spur gear 47 drives the clamping roller 15 to reverse Turning clockwise, the conveying wheel 13 conveys the mat to the right through the conveyor belt 14, the clamped roller 15 clamps the upper side of the mat and conveys it to the right, and the cleaning roller 16 polishes and cleans the bamboo surface of the mat. The mat is conveyed to the right into the drying channel 20, and due to the gravity of the mat itself, the first motor 39 starts and drives the driving sprocket 36 to rotate, and the driven sprocket 37 is driven to rotate by the chain 38, and the driving sprocket 36 is driven The blower fan 21 rotates to blow air, and the heating net 32 heats it, and then the hot air is blown onto the mat for high-temperature drying. The driven sprocket 37 drives the suction fan 22 to rotate to suck out the humid air in the drying channel 20 to ensure the dryness of the mat. As a result, the mat after the drying slides off from the opening on the lower side of the drying channel 20 and is collected.

The beneficial effect of the present invention is that: by dipping the mat into the cleaning solution during the transportation process, the invention polishes and cleans the bamboo surface, removes burrs and stains on the bamboo surface of the mat, and then quickly heats the mat to ensure that is not affected by moisture during subsequent processing. At the same time, the device can be adjusted according to different width mats to ensure that the mats will not shift during the transportation.

In the above manner, those skilled in the art can make various changes according to the working mode within the scope of the present invention.

1. A rapid cleaning device for cooling mat production, including a washing machine;
the washing machine is provided with a cleaning chamber with an upward opening. Conveyor wheels are rotatably provided on the left and right sides between the front and rear walls of the washing chamber. It is recessed and immersed in the cleaning liquid. A clamping roller is rotatably connected to the front and rear walls of the cleaning chamber above the conveying wheel. The cleaning chamber is rotatable between the front and back walls of the cleaning chamber and on the upper side of the recess of the conveyor belt. There are cleaning rollers. The clamping roller on the left side clamps the mat and inputs it to the right. The mat is conveyed down into the cleaning liquid through the conveyor belt, and the bamboo surface of the mat is polished by the cleaning roller. And cleaning, and then convey the mat to the upper right by the conveyor belt, and clamp the mat to the right by the clamping roller on the right;
the upper side of the left wall of the cleaning chamber is connected with an inlet opening to the right, and a limit block is symmetrically and slidably arranged in the front and rear of the inlet. The guide rails are used to limit the front and back ends of the mat through the limiting block, and the front and back ends of the mat are passed through the guide rails on the front and back sides respectively to further position the transportation of the mat to avoid the occurrence of the mat offset.

2. The rapid cleaning device for mat production according to claim 1, characterized in that: an adjusting device is provided on the upper side of the inlet, and the adjusting device can adjust the interval between the limiting blocks, and is further applicable to Mats of different widths;
a drying channel is communicated with the upper side of the right wall of the cleaning chamber, and a drying device is arranged in the right wall of the drying channel. The drying device is provided with a blower fan, and the upper side of the blower fan is provided with a suction fan for cleaning. The subsequent mat enters the drying channel, the blower fan blows hot air onto the mat for high-temperature drying, and the humid hot air is sucked out by the suction fan to ensure the drying of the air in the drying channel;
a transmission device is arranged in the rear wall of the cleaning chamber, and the transmission device can synchronously drive the conveying wheel, the clamping roller and the cleaning roller to rotate.

3. The rapid cleaning device for mat production according to claim 1, characterized in that the adjustment device comprises an adjustment cavity which is symmetrically arranged forward and backward and communicates with an upper wall of the adjustment cavity, and the adjustment cavity is capable of sliding forward and backward in the adjustment cavity. There is an adjusting block, the clamping roller is fixedly connected to the lower end of the adjusting block, and a screw threaded to the adjusting block is rotatably provided between the front and rear walls of the adjusting cavity;
a bevel gear cavity is provided in an inner wall between the adjustment cavities, and a driven bevel gear is fixedly provided in the bevel gear cavity at one end of the screw near the center of symmetry. The upper wall of the bevel gear cavity is rotatably provided with A driving bevel gear that is engaged with the driven bevel gears on the front and back sides. The driving bevel gear is fixedly provided with a power shaft at a shaft center, and a rotary disc is fixedly arranged at the upper end of the driving shaft.

4. The rapid cleaning device for mat production according to claim 2, characterized in that the drying device comprises a blowing cavity connected to the right wall of the drying channel, and the blowing fan is rotatably provided in the blowing cavity. On the right wall, a heating net is fixed on the left side in the blow cavity;
the upper side of the blowing cavity is provided with an air suction cavity connected to the drying channel. The air suction fan is rotatably provided on the right wall of the air suction cavity. There are ventilation nets.

5. The rapid cleaning device for mat production according to claim 4, characterized in that: a sprocket cavity is provided on the right side of the blowing cavity and the air suction cavity, and a lower side of the sprocket cavity is rotatably provided with A driving sprocket fixedly connected to the blower fan, a driven sprocket fixed to the suction fan is rotatably provided on the upper side of the sprocket cavity, the driving sprocket and the driven chain A chain is wound around the wheels.

6. The rapid cleaning device for producing mats according to claim 5, characterized in that: a first motor is fixedly arranged at the lower end of the right wall of the sprocket cavity, and the active sprocket is dynamically connected to the left end of the first motor.

7. The rapid cleaning device for mat production according to claim 4, characterized in that: the right side of the blowing chamber is provided with an air inlet opening to the right, and the upper side of the right wall of the suction chamber is provided with a communication Open the air outlet to the right.

8. The rapid cleaning device for mat production according to claim 1, characterized in that the transmission device comprises a transmission cavity provided in a rear wall of the cleaning cavity, and a middle lower side of the transmission cavity is rotatably provided with A driving pulley fixedly connected to the rear end of the cleaning roller, and left and right sides in the transmission cavity are symmetrically and rotatably provided with driven pulleys fixedly connected to the rear end of the conveying wheel. A driven belt is wound around the driven pulleys. A driving spur gear is fixedly connected to the rear end of the driven pulley. An upper side of the driving spur gear is meshed with a fixedly connected to the rear end of the clamping roller. Driven spur gear.

9. The rapid cleaning device for mat production according to claim 8, characterized in that: a second motor is fixedly arranged in the rear wall of the transmission cavity and directly opposite to the rear side of the active pulley, and the active pulley is power-connected At the front end of the second motor.

10. The rapid cleaning device for producing mats according to claim 1, characterized in that the lower sides of the front and rear walls of the cleaning chamber are symmetrical and fixed with arc-shaped upper rails, and the front and rear walls of the cleaning chamber are on the upper side. The lower side of the guide rail is symmetrical and fixed with a lower guide rail, the arc radius of the lower guide rail is larger than the radius of the upper rail, and the front and rear ends of the upper part of the conveyor belt extend into the upper rail on the front and back sides, The front and back ends of the lower part of the conveyor belt extend into the lower rails on the front and back sides.
